(19) United States
(12) Patent Application Publication
(10) Pub. No.: US 2011/0280038 A1
(43) Pub. Date: Nov. 17, 2011

(54) Systems for and methods of illumination at a high optical solid angle

(76) Inventor: Hwan J. Jeong, Los Altos, CA (US)

(21) Appl. No.: 13/068,179

(22) Filed: May 4, 2011

Related U.S. Application Data
(60) Provisional application No. 61/395,347, filed on May 12, 2010.

(51) Int. Cl. F21V 33/00

(52) U.S. Cl. 362/554; 362/154; 362/101

(57) ABSTRACT

Illumination systems and methods that utilize the higher or outer portions of the optical solid-angle space to increase the illumination intensity are disclosed. The illumination systems and methods include introducing illumination light through at least one side surface of a transparent slide that operably supports a sample on its top surface. The light fills at least a portion of the optical solid-angle space between 1 and n, and extends out to n. Light from the filled portion of the optical solid-angle space illuminates the sample through the top surface of the transparent slide. The disclosed illumination systems and methods are suitable for use in applications, such as dark-field imaging, fluorescence imaging, Raman spectroscopy, DNA analysis and like applications requiring high-intensity illumination.

### CROSS-REFERENCE TO RELATED APPLICATIONS

This patent application claims the benefit of U.S. Provisional Patent Application Ser. No. 61/395,347, filed May 12, 2010, which is incorporated by reference herein.

### FIELD

This patent specification relates to illumination systems and method, and in particular relates to systems and methods that provide for illumination at a high optical solid angle.

### BACKGROUND

Some optical applications such as dark-field microscopy, fluorescence microscopy, Raman spectroscopy, DNA analysis, etc., usually require an intense illumination of the sample. However, intense illumination is difficult to achieve without using an extremely bright source, such as a laser.

Lasers can provide a high illumination level. However, it is very difficult or expensive to change the illumination wavelength with a laser source because most lasers emit a single wavelength or in a narrow spectral band. For example, U.S. Pat. No. 6,682,927 introduces a laser beam through a side surface of the sample slide to illuminate the sample. However, it collimates the illumination beam without utilizing the solid-angle space available for the illumination. Therefore, it can provide an intense illumination with only an extremely bright source such as a laser beam.

Conventional light sources such as an arc lamp, a halogen lamp, etc., usually allow an easy change of wavelength, thanks to their wide spectral bandwidth. However, the illumination intensity is usually limited because of the relatively low brightness of these sources and the limited solid angle available for the illumination in conventional illumination schemes. This is especially true for the dark-field mode of illumination.

Conventional immersion illumination techniques can increase the illumination intensity significantly because they can fill more of the optical solid-angle space with illumination rays than conventional dry illumination techniques. However, they require a bulky illumination system with a positive lens, which needs to be optically coupled with the sample or the sample slide. The optical coupling requires an index-matching liquid in the interface between the lens and the sample slide and makes sample handling difficult. Also, the requirement for a high NA illuminator adds a sizable cost and the retrofit of an immersion illuminator to existing imaging systems is generally difficult. Moreover, it is virtually impossible to achieve the theoretical maximum numerical aperture of the illuminator because of optical and mechanical conflicts with other parts such as the sample stage and the finite thickness of the sample slide. This causes the peripheral part of the optical solid-angle space to be void of illumination rays, resulting in weaker illumination intensity than the theoretical maximum intensity achievable.

### SUMMARY

It is well known in the art that if the brightness (W/cm²steradian) of the illumination light does not change with the solid-angle space it occupies, the intensity of the illumination on the sample is proportional to the total optical solid-angle the illumination light occupies. Therefore, the illumination light should occupy as much optical solid-angle space as possible while maintaining the brightness in order to maximize the illumination intensity. The central or lower part of the optical solid-angle space can easily be filled with the illumination rays using a conventional illuminator. However, it is very hard to fill the peripheral or “higher” part of the optical solid-angle space using a conventional illuminator.

The systems and methods disclosed herein allow for filling the peripheral or high part of the optical solid-angle space with illumination rays. In an example, this is done by introducing illumination light through at least one side surface of a sample slide (transparent slide) that supports a sample to be illuminated. The systems and methods do not need a liquid-filled interface between the illuminator and the slide. This facilitates the retrofitting of the systems described herein to existing optical systems.

The systems and methods disclosed herein can fill the peripheral or outer (higher) part of the optical solid-angle space with illumination rays to increase the illumination intensity or to otherwise provide illumination to a sample in a manner that has not heretofore been possible.

Accordingly, an aspect of the disclosure is a method of illuminating a sample. The method includes supporting the sample on a transparent slide. The transparent slide has a refractive index n, opposing top and bottom substantially planar surfaces, and at least one side. The transparent slide defines an optical solid-angle space. The sample is operably supported on the upper planar surface of the transparent slide. The method also includes introducing light into the transparent slide through the at least one side of the transparent slide to illuminate a portion of the optical solid-angle space between 1 and n, with the illuminated portion extending out to n. The light in the illuminated portion of the optical solid-angle space illuminates the sample through the substantially planar upper surface.

Another aspect of the disclosure is a method of illuminating a sample. The method includes providing first and second transparent slides having respective first and second refractive indices n₁ and n₂ and first and second optical solid-angle spaces. Each of the transparent slides has opposing substantially planar surfaces and at least one side. The method includes sandwiching the sample between the planar surfaces of the first and second transparent slides. The method also includes introducing light into the first and second transparent slides through each of the at least one sides to fill respective first and second portions of the first and second optical solid-angle spaces. The first filled portion is between 1 and n₁ and extends out to n₁, while the second filled portion is between 1 and n₂ and extends out to n₂. The light in the filled first and second portions illuminates the sample.

Another aspect of the disclosure is an illumination system for illuminating a sample at a high optical solid angle, with the sample having top and bottom surfaces. The system includes a transparent slide having top and bottom substantially planar surfaces and at least one side. The sample is operably supported by the transparent slide with its bottom surface in optical contact with the top substantially planar surface of the transparent slide. The transparent slide has a refractive index n and defines an optical solid-angle space. The system also includes a light source optically coupled to the at least one side of the transparent slide such that light from the light source enters the at least one side and fills a portion of the optical solid-angle space between 1 and n, wherein the filled portion extends out to n. Light from the filled portion illuminates the sample through the top substantially planar surface of the transparent slide.

### BRIEF DESCRIPTION OF THE DRAWINGS

The inventive body of work will be readily understood by referring to the following detailed description in conjunction with the accompanying drawings, in which:

FIG. 1A shows the relationship between geometrical and optical solid angles.

FIG. 1B shows the ray paths for a conventional illumination of a transmissive sample.

FIG. 1C shows the ray paths for a conventional illumination of a reflective sample.

FIG. 1D shows the optical solid-angle space available for the conventional illumination.

FIG. 1E shows the optical solid-angle space used by a conventional dark-field illumination.

FIG. 1F shows a conventional immersion illumination system.

FIG. 1G shows an ultimate conventional immersion illumination system in which the sample is supported by the hemispherical lens.

FIG. 1H shows the optical solid-angle space covered by a conventional immersion illuminator.

FIG. 2A shows the ray paths for a sideway through-the-slide illumination.

FIG. 2B shows the optical solid-angle space available for the sideway through-the-slide illumination.

FIG. 3A shows the ray paths for a dual slide sideway through-the-slide illuminator.

FIG. 3B shows the ray paths for a dual slide sideway through-the-slide illuminator with index matching liquid filling the space between the two slides.

FIG. 4A shows the ray paths for the conventional as well as the sideway through-the-slide illumination system.

FIG. 4B shows the ray paths for the conventional as well as a sideway through-the-slide illumination system when the sample is sandwiched between the two slides.

FIG. 5A shows an example of fiber-coupled sideway through-the-slide illumination system.

FIG. 5B shows another example of fiber-coupled sideway through-the-slide illumination system.

FIG. 5C shows the optical solid-angle space covered by a fiber-coupled sideway through-the-slide illuminator.

FIG. 5D shows an example of sideway through-the-slide illumination system with a tapered light-pipe between the fiber bundle and the slide.

FIG. 5E shows another example of sideway through-the-slide illumination system with multiple tapered light-pipes between the fiber bundles and the slide.

FIG. 5F shows an example of sideway through-the-slide illumination system with a coupling lens.

FIG. 5G shows another example of sideway through-the-slide illumination system with multiple coupling lenses.

FIG. 5H shows an example of sideway through-the-slide illumination system with both a tapered light-pipe and a coupling lens.

FIG. 6A shows an example of well-directed illumination ray bundle introduced through one of the side surfaces of the sample slide.

FIG. 6B shows the area in the optical solid-angle space occupied by the illumination ray bundle shown in FIG. 6A.

FIG. 6C shows an example of two well-directed illumination ray bundles introduced through two opposing side surfaces of the sample slide.

FIG. 6D shows the area in the optical solid-angle space occupied by the illumination ray bundles shown in FIG. 6C.

### DETAILED DESCRIPTION

A detailed description of the inventive body of work is provided below. While example embodiments are described, it should be understood that the inventive body of work is not limited to any one embodiment, but instead encompasses numerous alternatives, modifications, and equivalents, as well as combinations of features from the different embodiments. In addition, while numerous specific details are set forth in the following description in order to provide a thorough understanding of the inventive body of work, some embodiments can be practiced without some or all of these details. Moreover, for the purpose of clarity, certain technical material that is known in the related art has not been described in detail in order to avoid unnecessarily obscuring the inventive body of work. The claims are incorporated into and constitute part of this specification.

Note that the sample-supporting coplanar glass plate discussed herein is commonly called “sample slide,” “microscope slide,” “transparent slide” or just “slide”. The same naming convention is adopted herein. All these names are used interchangeably herein and such use is intended to provide an expanded definition rather than a limited definition.

Also, in the Figures that show an optical solid-angle space, the regions or portions of the optical solid-angle space where no light passes are shown as shaded while the regions of the optical solid-angle space where light passes is shown as white. Illumination that employs the outer or higher portion of the optical solid-angle space is also referred to herein as “high optical-solid-angle illumination” or “illumination at a high optical-solid angle.” In an example, this region of the optical solid-angle space is defined as being between 1 and n, where n is the refractive index of the transparent slide.

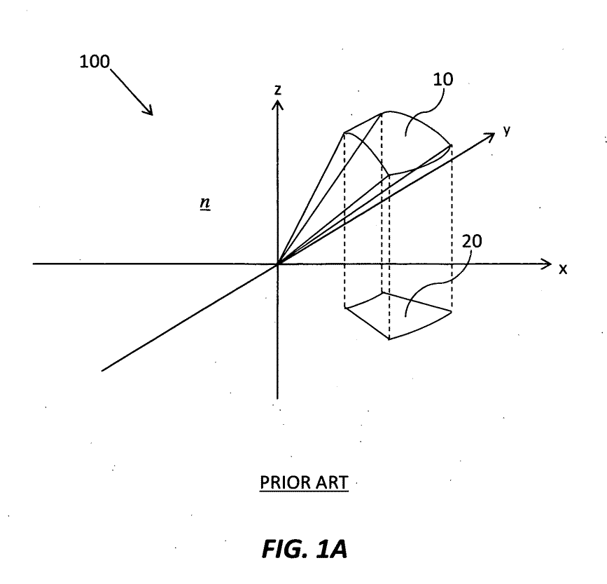

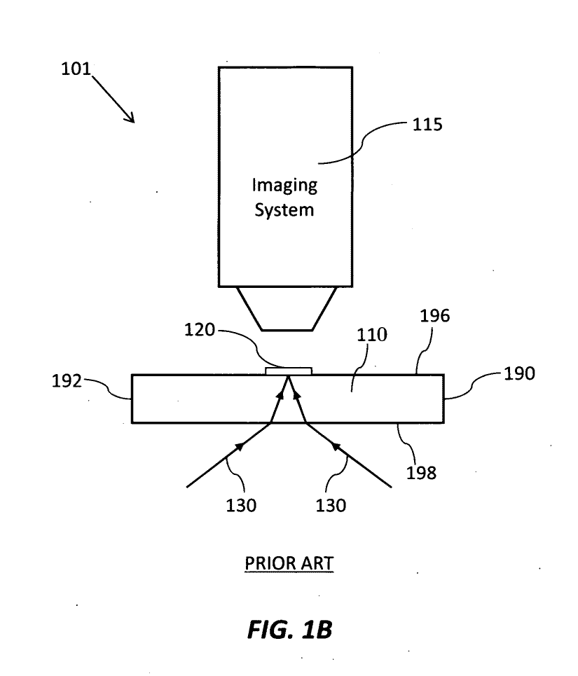

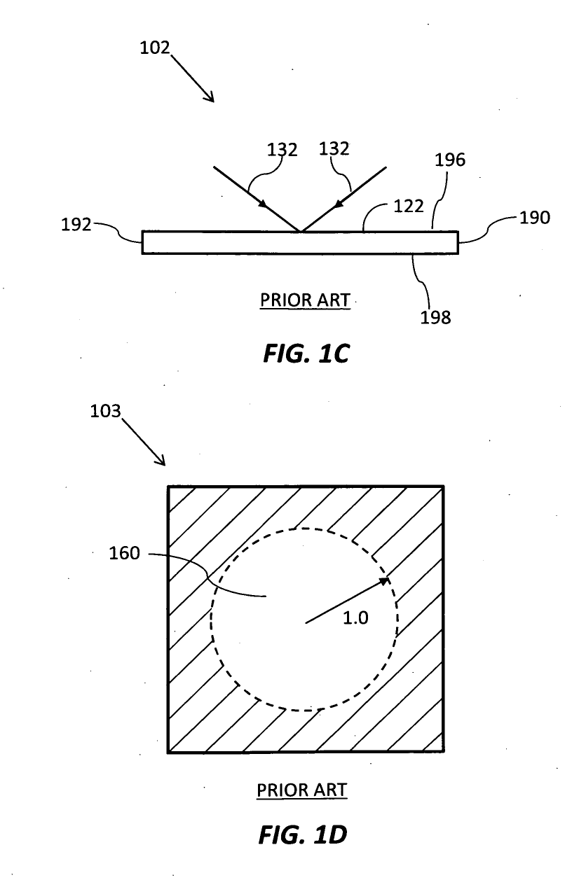

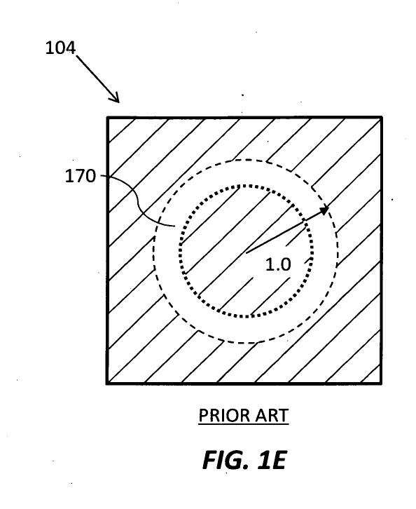

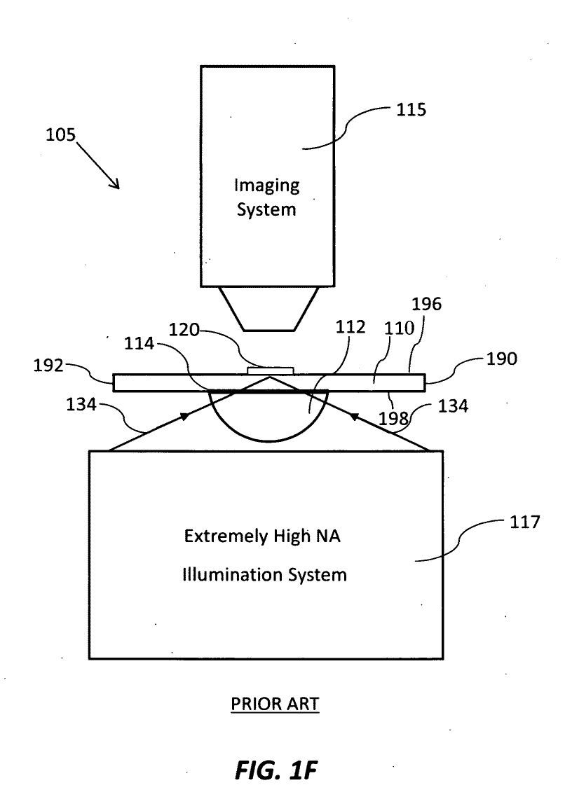

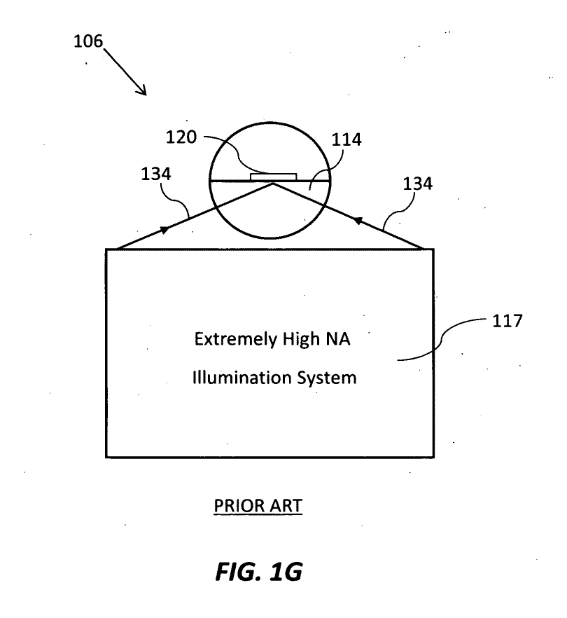

The systems and methods disclosed herein relate to providing relatively intense illumination into the otherwise untapped optical solid-angle space to increase the illumination level. Therefore, it is important to correctly understand the concept of optical solid-angle. FIG. 1A shows the relationship between geometrical solid angle 10 and the corresponding optical solid angle 20.

Optical solid-angle is the square of the refractive index of the sample space times the projection of geometrical solid angle on the sample plane.

That is,

dΩₒ=n²·cos(θ)dΩ_{g} (1)

where Ωₒ: optical solid-angle;

Ω_{g}: geometrical solid angle;

n: the refractive index of the sample space; and

θ: the angle between dΩ_{g} and the sample plane

The optical solid-angle space available for illumination can have a variety of different shapes. If not specifically mentioned, the volume of the optical solid-angle or just optical solid-angle herein means the total two-dimensional volume (area) of optical solid-angle space available for illumination. Also, note that the solid angle has nothing to do with the physical thickness or physical volume of the optical material around the sample. It is related only to the refractive index of the material. Geometrical solid angle will also be called physical solid angle herein. That is, the two terms will be used synonymously herein.

It is important to understand the difference between an optical solid-angle and geometrical solid angle. For example, the maximum geometrical solid angle is 4π, which is the surface area of a sphere of unit radius. However, the maximum optical solid-angle is 2n²π, the square of the refractive index times the area of two circles of unit radius.

The numerical aperture (NA) of an optical system is directly related to the optical solid-angle the optical system spans. That is,

Ωₒ=π(NA)² (2)

Note that the refractive index of the sample space is absorbed in the definition of the numerical aperture (NA). What we care herein is the optical solid-angle, not the geometrical one. Therefore, from now on, the word “solid angle” will mean an optical solid-angle by default.

The illumination intensity on a sample is expressed as follows.

I=∫∫BdΩₒ (3)

where B is the brightness of the source seen in the sample space and Ωₒ is the optical solid-angle,

Note that brightness is a casual term and is more formally called “luminance” in photometry and “radiance” in radiometry. Intensity is also a casual term and more formally called “illuminance” in photometry and “irradiance” in radiometry. The conversion between photometric units and radiometric units is straightforward and all the concepts and equations presented herein are applicable to both photometry and radiometry without modification. Therefore, photometry and radiometry will not be distinguished and the casual terms will be used to cover both photometry and radiometry. Also note that the transmission of the illumination system is absorbed into the definition of brightness in equation (3) in order to avoid unnecessary complications.

One does not have much control over the brightness of the source seen in the sample space because it is only controlled by the original brightness of the source and the transmission of the illuminator system, not by the optical design of the illuminator. If one cannot control the brightness of the source, filling all the optical solid-angle space available for illumination with the brightest part of the source is the only way to get the maximum illumination intensity at the sample plane. In this case, B in equation (3) is constant over the illumination solid-angle space. Therefore, equation (3) becomes;

I=BΩₒ^{ill} (3a)

where Ωₒ^{ill} the total optical solid-angle space occupied by the illumination rays

Equation (3a) indicates that the maximum illumination intensity achievable depends on both the source brightness and the total optical solid-angle space available for the illumination. However, the systems and methods disclosed herein are not about how to make the source brighter but rather are about how to achieve a higher illumination intensity using the same source. Therefore, in order to compare the strengths and weaknesses of different illumination schemes in a fair fashion, the same source brightness will be assumed in all the illumination schemes and only the total available optical solid-angle space available for the illumination will be compared between the different illumination schemes.

In conventional illumination schemes such as bright-field illumination for a dry microscope 115 shown in FIG. 1B, the illumination rays 130 enter the sample slide 110 through the bottom or top surface 198 and pass through slide 110 without experiencing any internal reflection from the surfaces before reaching sample 120. The ray paths inside slide 110 show that even if the illumination rays occupy the entire solid-angle space outside the slide, they do not occupy the entire solid-angle space inside the slide, leaving a large amount of solid-angle space unoccupied inside the slide due to the refraction at the entering surface.

FIG. 1C shows the ray paths 132 when a reflective sample 122 is illuminated in a conventional way. The maximum numerical aperture a conventional dry illuminator can achieve is 1.0 as shown in FIG. 1D. Consequently, the volume of the solid-angle space available for a conventional dry illumination 160 is π at its maximum by equation (2). The actual illumination solid angle in the conventional illumination schemes is even smaller than 7C. Especially, in case of the conventional dark field illumination, the total solid-angle space occupied by the illumination rays is usually much smaller than π because a significant part of the solid-angle space is used by the imaging system. In this case, the solid-angle space available for the illumination forms a narrow ring 170 as shown in FIG. 1E. This kind of relatively small illumination solid angle is a major reason for insufficient illumination intensity in conventional illumination systems. Note that a dry optical system means that either air or vacuum occupies the volume between the sample and the optical system.

A relatively small illumination solid angle is unavoidable if the sample is suspended in air. However, in the real world, most samples are placed in contact with a surface of a slide. The contact is usually made by the use of an index-matching liquid between the sample and the slide. In this case, the available solid angle for the illumination is much larger than the previous case because of the refractive index factor of the slide as shown in equation (1). In this case, the maximum optical solid-angle space an illuminator can utilize becomes πn² where n is the refractive index of the slide. However, as stated previously, conventional dry illuminators cannot take advantage of the increased optical solid-angle space.

In order to utilize the increased part of the optical solid-angle space, an immersion illuminator can be used. FIG. 1F shows an example of the conventional immersion illuminator which requires an extremely high NA illumination optics 117. The last optical element of the immersion illuminator is a hemispherical lens 112, which is in optical contact with sample slide 110 through an index-matching liquid in their interface 114. As shown in FIG. 1F, this kind of immersion illuminator allows illumination rays 134 to have higher incidence angles inside the sample slide than the conventional dry illuminators.

FIG. 1G shows an ultimate immersion illuminator. It eliminates the sample slide and the sample is placed directly on the hemispherical lens in order to allow illumination rays to have an even higher incidence angles inside the sample slide. In principle, the incidence angle of rays 134 can reach the maximum value of 90° inside the sample slide. Thus, this kind of immersion illuminator can fill all the optical solid-angle space with illumination rays in principle. However, in practice, it is virtually impossible to fill all the optical solid-angle space with an immersion illuminator due to the optical and mechanical interferences and collisions between different parts in the illuminator and sample stage and other difficulties such as anti-reflection coatings on highly curved surfaces.

The practical immersion illumination systems leave the peripheral part of the solid-angle space void of illumination rays. This is shown in FIG. 1H. Region 162, which can be occupied by illumination rays from an immersion illuminator, is bigger than region 160 in FIG. 1D that can be utilized by dry illuminators. However, the peripheral region 180 is still void of illumination rays. Thus, immersion illuminators can significantly increase illumination intensity but cannot attain the maximum illumination intensity possible. Also, it is very inconvenient to use immersion illuminators because of the index-matching liquid, the bulky illuminator body, and mechanical collisions between different parts, etc.

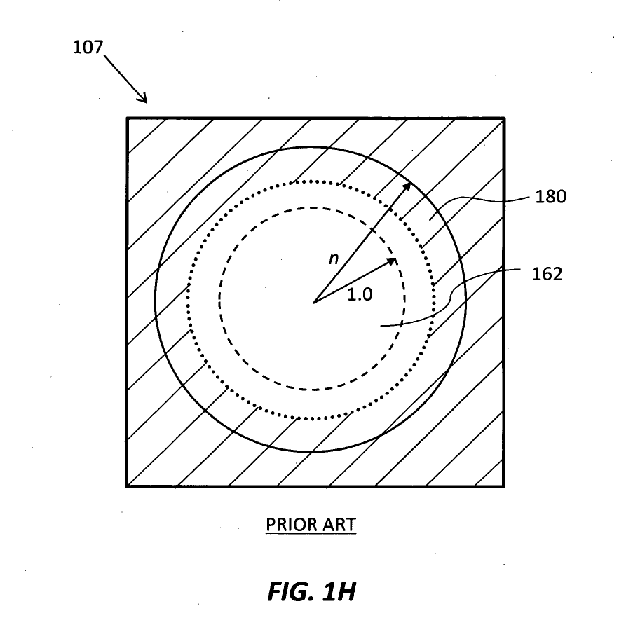

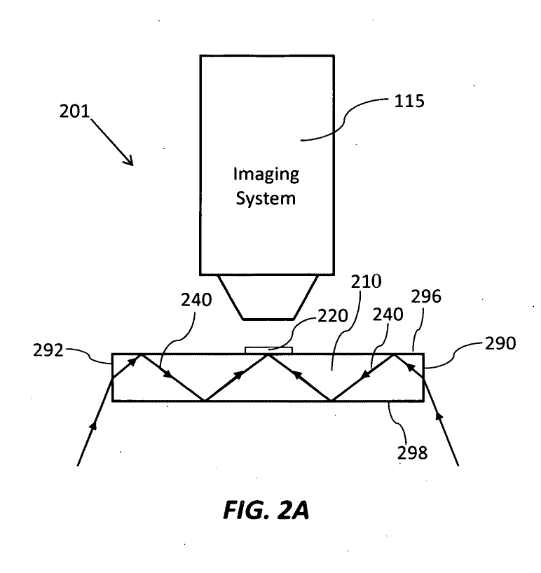

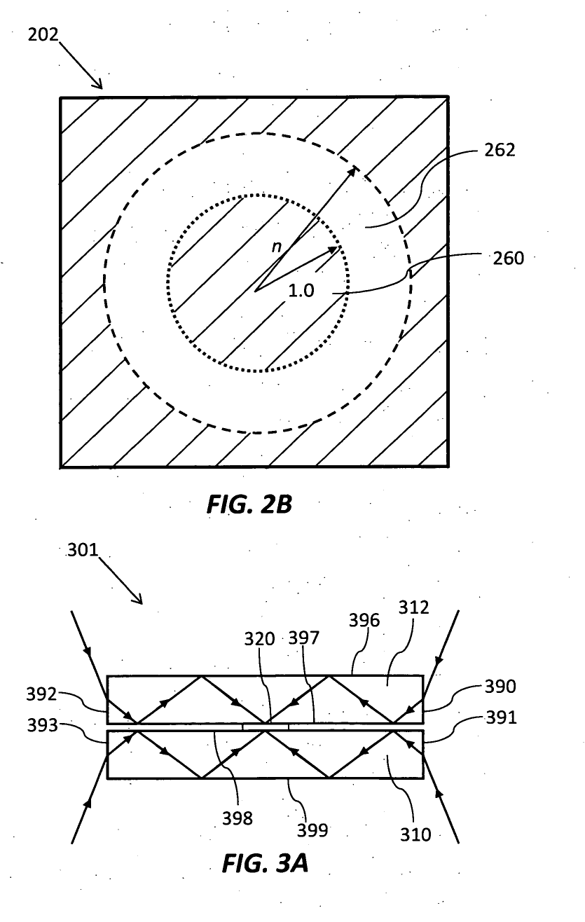

The illumination systems and methods disclosed herein fill the unoccupied solid-angle space inside the slide with new illumination rays. In particular, the systems and methods disclosed herein solve these problems by bringing the illumination light through at least one side surface of the sample slide. The top and bottom surfaces of the sample slide are used to constrain the illumination in the plane normal to the microscope axis. FIG. 2A shows an example of the sideway through-the-slide illumination disclosed herein. Illumination rays 240 enter sample slide 210 through the side surfaces 290 and 292 rather than the top 296 or bottom surface 298. No liquid interface between the illuminator and the side surfaces of the sample slide is needed. Some of the rays experience internal reflections before reaching sample 220. FIG. 2A shows an imaging system 115 operably arranged relative to sample 220. Imaging system 115 is configured to form an image of the illuminated sample 220. Here, forming an imaging also means allowing a viewer to see an image of a sample by looking through the imaging system, e.g., as in the case where imaging system 115 comprises a microscope viewing system.

The maximum optical solid-angle space these side-entering rays can occupy is shown in FIG. 2B. The side-entering rays do not occupy the center portion 260 of the optical solid-angle space but occupy the peripheral part 262 of the optical solid-angle space which is shown as an annular ring in FIG. 2B. The annular optical solid-angle space that can be utilized by the new illumination technique can be quite large. For example, if the refractive index of the slide is 1.5, the two dimensional volume of the annular optical solid-angle space is 1.25π, which is larger than the maximum solid-angle space available to conventional dry illumination systems. If a high index material such as a high index flint glass, sapphire, etc. is used for the sample slide, the volume of the annular optical solid-angle space available for the new illumination technique is even larger. This is the very reason why the illumination systems and methods disclosed herein can achieve significantly higher illumination intensity on the sample. This is especially true for the dark-field mode illumination case.

By comparing the annular ring area of FIG. 2B with that of FIG. 1E, it can be seen that the illumination systems and methods disclosed herein can provide a much higher illumination level in the dark field illumination mode without the use of any liquid interface. Note that synthetic sapphire is less expensive than natural sapphire and transmits short wavelengths such as ultraviolet or deep ultraviolet light very well. Also note that, strictly speaking, crystals such as sapphire are optically different from glass because of their birefringence. However, they are considered as glass materials herein because the birefringence of crystal materials is not a substantial concern for this kind of non-imaging application.

If the refractive index of the sample is smaller than that of the sample slide, the illumination rays can be internally reflected completely at the interface between the sample and the slide. It is well known that a completely internally reflected ray forms a non-radiative or evanescent wave inside the sample and the intrusion depth of the evanescent wave depends on the incidence angle of the ray at the interface. The incidence angle of the ray at the interface is directly related to its incidence angle at the entrance surface to the slide because all the subsequent internal reflections of the ray by the slide surfaces do not change the ray's incidence angle at the interface between the sample and the slide, as long as the top and bottom surfaces of the slide are parallel to each other and all the side surfaces are perpendicular to the top and bottom surfaces. This means that the intrusion depth of the illumination light into the sample can be completely controlled by the incidence angle of the ray at the entering surface to the slide. Thus, the sideways through-the-slide illumination systems and methods disclosed herein allow for good control of the penetration depth of the illumination rays into the sample. Controlling the penetration depth of the illumination light into the sample is very useful for some applications, such as fluorescence microscopy.

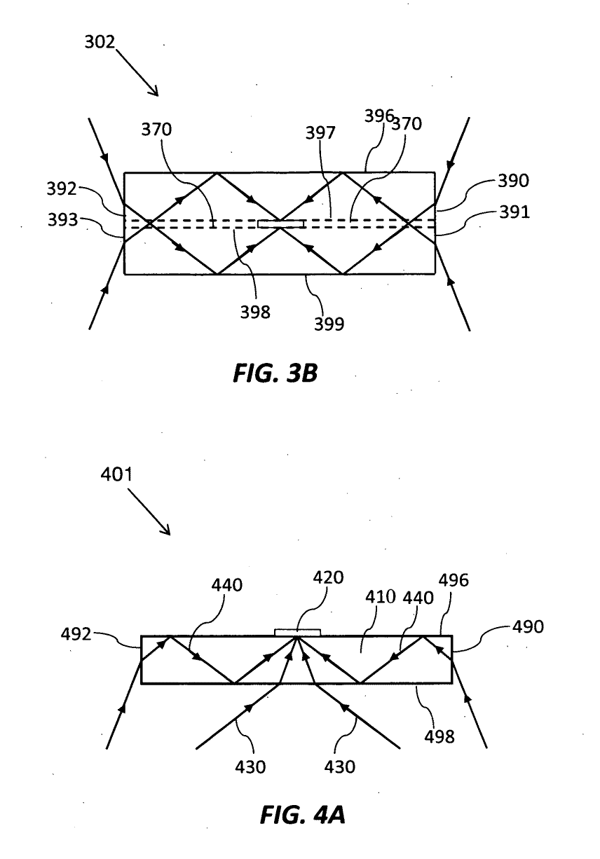

The illumination intensity can further be increased by increasing the optical solid-angle available for the illumination. FIG. 3A shows a simple way of further increasing the illumination level. It sandwiches sample 320 between two slides, 310 and 312, in order to double the optical solid-angle space available for the illumination. In FIG. 3B, the space (gap) between the two slides where the sample resides is filled with index-matching liquid 370 in order to ensure good optical contact between the sample and the slides and to mix the illumination rays between the two slides. The thicknesses of the two slides shown in FIGS. 3A and 3B are the same. However, they need not be the same. Actually, the top slide can be a thin cover glass. Also, if the sample is very transparent, the top layer of the sample itself can function as a slide. Therefore, this kind of illumination intensity doubling can happen naturally even with suitable configured single slide. In an example, the two slides 310 and 312 have different refractive indices n₁ and n₂ (or n and n′), while in another example, they have the same refractive index n.

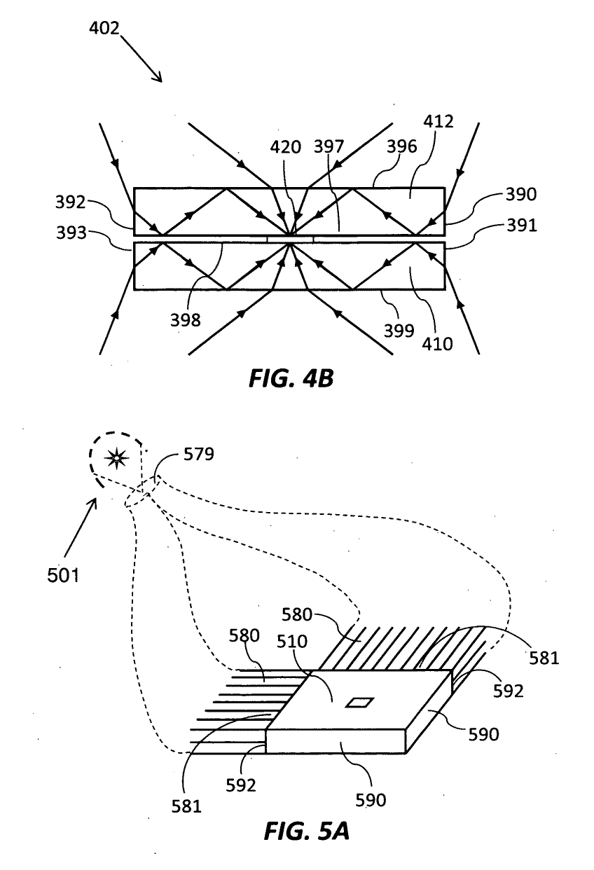

If the illumination level is to be further increased, the conventional and through-the side illumination techniques disclosed herein can be used simultaneously. FIG. 4A shows the simultaneous use of conventional and through-the-side illumination techniques, where the conventional illumination rays 430 occupy the central portion of the available optical solid-angle space and the through-the-side illumination rays 440 occupy the peripheral part of the optical solid-angle space. In this way, the highest illumination intensity can be achieved because the simultaneous use of both conventional and the new illumination techniques allows for utilizing the entire optical solid-angle space available for the illumination.

Another application of the simultaneous use of both the conventional and through-the-side illumination techniques is to achieve a very incoherent illumination, which is the opposite of coherent illumination. Illumination is called incoherent when the illumination light has no spatial coherence between any two points in the illuminated field. The spatial coherence length of illumination light is inversely proportional to the numerical aperture of the illumination beam of rays. In other words, the spatial coherence area of illumination light is inversely proportional to the optical solid-angle space the illumination rays occupy. Therefore, incoherent illumination requires illumination with a large optical solid-angle. The larger the illumination solid angle, the more incoherent the illumination field.

Completely incoherent illumination cannot be achieved in the real world because it requires an infinite illumination solid angle. However, a virtual or practical degree of incoherent illumination can be achieved by making the optical solid-angle space available for the illumination quite a bit larger than the imaging system's collection solid angle and filling the whole available optical solid-angle space with mutually incoherent illumination rays. For example, if a high-index material is used for the sample slide, and the whole optical solid-angle space is filled with mutually incoherent illumination rays through the simultaneous use of the conventional and through-the-side illumination techniques, then the illumination can be considered virtually incoherent for most applications.

An imaging system becomes linear with respect to the intensity rather than the complex amplitude of the input light when the illumination is incoherent. Also, most image sensor's responses are linear to the intensity distribution of the image. Thus, incoherent illumination makes the entire imaging system, including both the optical system and the image sensor, linear to the intensity of the input light. This allows direct use of well-developed linear theories for image processing.

FIG. 4B shows a way of further increasing the illumination intensity. Sample 420 is sandwiched between slides 410 and 412 to double the illumination intensity compared with the single plate configuration shown in FIG. 4A. Also, this configuration further reduces the spatial coherence of the illumination light.

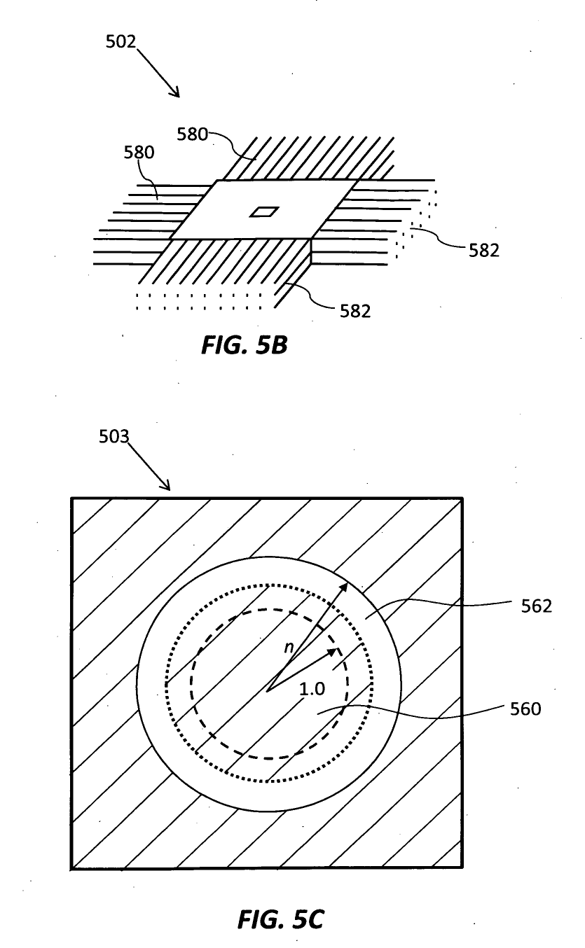

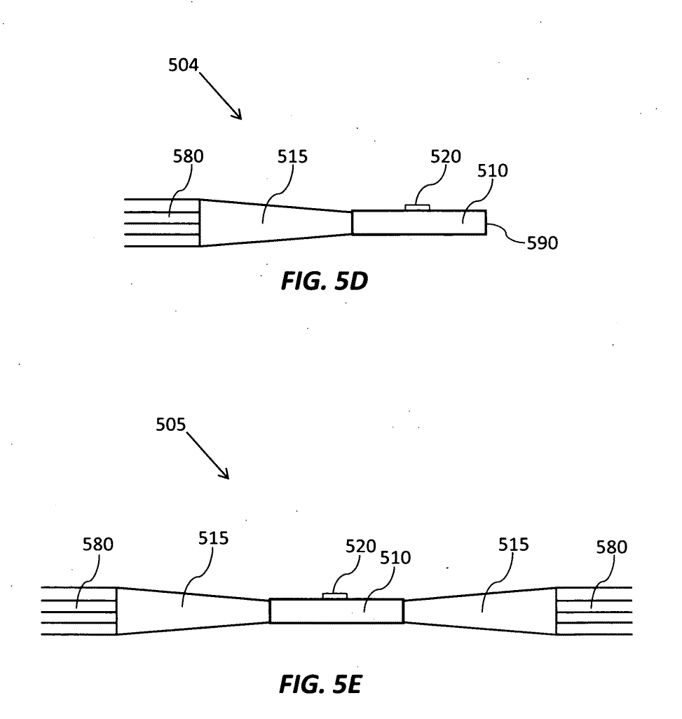

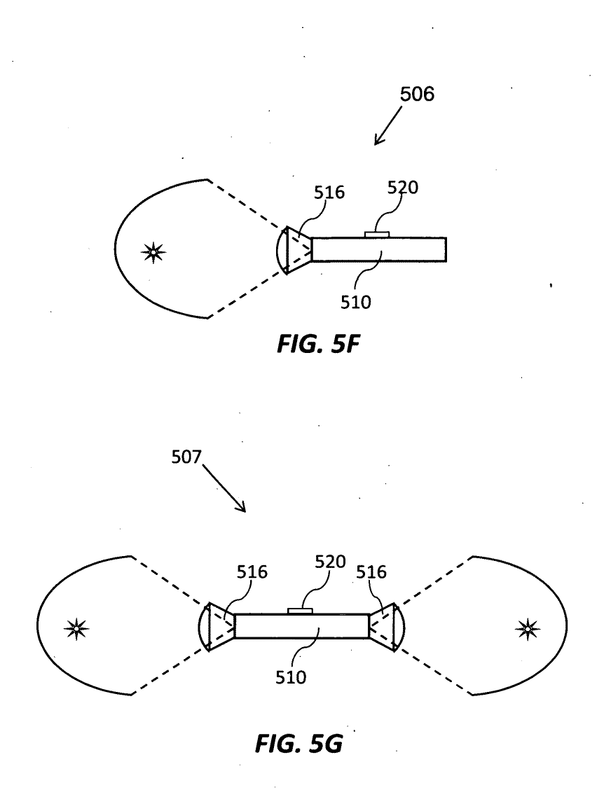

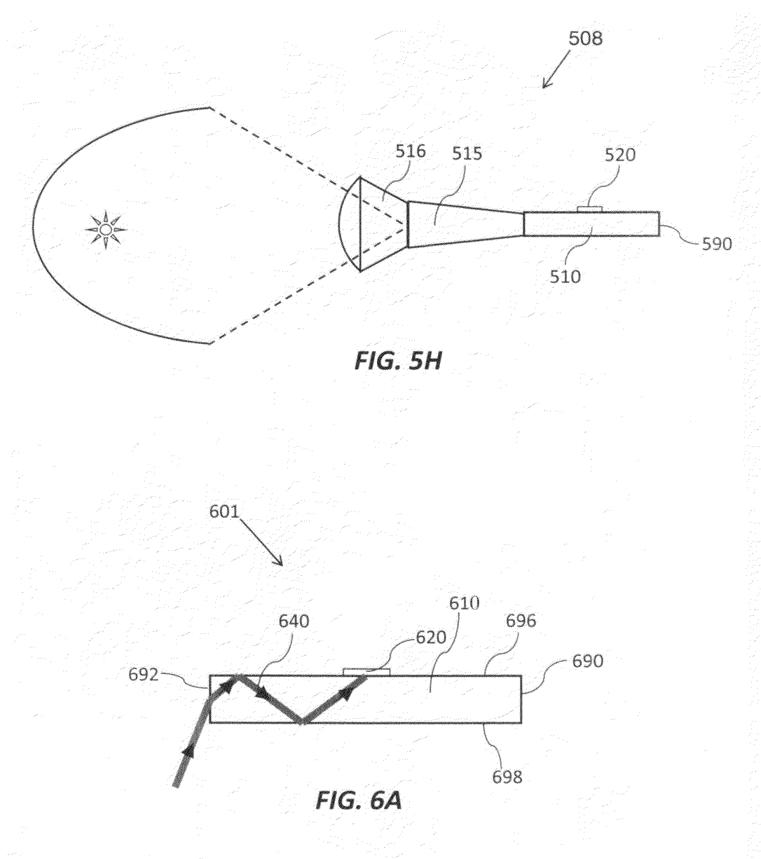

In order to make the new illumination technique work, light needs to be coupled into the slide through at least one of the side surfaces, and preferably through multiple side surfaces. As there are many different methods of coupling light into the slide, only a few examples of such light coupling methods are presented herein. FIG. 5A shows an example of light coupling into the slide using optical fibers. The illumination light from a light source 501 is coupled into slide 510 through the fiber bundles 580. Fiber bundles 580 have proximal ends 579 that are optically coupled to light source 501. Two side surfaces 592 of the slide are optically coupled to distal ends 581 of fiber bundles 580. No liquid is needed between the end surface of the fiber bundle at distal end 581 and the entrance surface 592 of the slide. This facilitates the retrofitting of the illumination systems disclosed herein to existing imaging systems, such as microscopes. However, anti-reflection coatings on surface 592 are recommended for a more efficient coupling of the light into the slide. The rest of the side surfaces 590 may be coated with a reflecting layer, e.g., of one or more highly reflecting materials such as aluminum, multilayer dielectrics, etc. for the recycling of the illumination light. The high-reflection coated side surfaces reflect the incident light back toward the sample. This kind of recycling of the illumination light can save a number of fiber bundles.

Optical fibers with a high numerical aperture and high packing density are recommended to achieve an intense sample illumination level. As long as the fibers are not severely bent, the numerical aperture of the light passing through the fiber is usually well preserved. That is, the numerical aperture of the output light from a fiber is nearly the same as the numerical aperture of the input beam that enters the fiber. Therefore, the range of the incidence angles of the illumination rays on the sample can be controlled by adjusting the numerical aperture of the input beam to the fiber bundle.

If the sample is highly absorptive of light and the slide is thin and small, then there may not be much light to be recycled by the highly reflective side surfaces of the slide. In this case, in order to achieve maximum illumination intensity on the sample, all the side surfaces may need to be coupled with fiber bundles as shown in FIG. 5B. No liquid is needed in the interfaces between the fiber bundles and the side surfaces of the slide. However, good anti-reflection coatings on the end surfaces of the fiber bundles and the side surfaces of the slide will improve the coupling efficiency of the illumination light.

If the top and bottom surfaces of the slide are not coated, there is a thin layer of evanescent wave outside of the surfaces carrying a sizable amount of energy. Anything touching the surfaces, even a dust particle, picks up a part of the energy in the evanescent wave and consequently causes energy loss in the illumination light. Therefore, the top and bottom surfaces of the slide must be kept clean and if the surfaces are not coated, any mechanical touching of the surfaces needs to be minimized in order to achieve maximum illumination intensity. If touching a large area of the surfaces is not avoidable, a high reflection coating on the area being touched is recommended.

The numerical apertures of the fibers commonly used for light delivery are usually not large enough for the illumination light to fill the whole optical solid-angle space available for the illumination. This case is shown in FIG. 5C. The illumination light provided through fiber bundles fills only a narrow peripheral part 562 of the optical solid-angle space. This kind of an incomplete filling of the optical solid-angle space leads to lower illumination light level.

Therefore, in order to maximize the illumination intensity, the range of the incidence angles of the illumination rays at the side surfaces of the slide should be increased. One of the many simple ways of increasing the range of the incidence angles of the illumination rays at the side surfaces of the slide is to insert a tapered light-pipe between the fiber bundle and the slide as shown in FIG. 5D. In this case, in order to obtain the highest illumination intensity on the sample, the brightness of the light beam should be maintained while passing through the tapered light-pipe 515. Steep tapering of the light-pipe can cause a significant loss of the brightness of the light beam. Therefore, a gradual tapering of the light-pipe is highly recommended. However, a gradual taper leads to a longer light-pipe which is usually not desirable. Therefore, there should be a good compromise between the length of the light-pipe and the loss of the brightness of the light beam.

In some cases, a computer simulation of the light propagation through the light-pipe may be needed to find a good compromise. In FIG. 5D, some side surfaces 590 of the slide are coated with highly reflective materials in order to save a number of tapered light-pipes. The coated side surfaces recycle the illumination light by reflecting the incident light back toward the sample. Of course, more tapered light-pipes can be used as shown in FIG. 5E. The use of more tapered light-pipes costs more but can provide more intense illumination levels on the sample, especially when the sample is highly absorptive and the slide is small and thin.

FIGS. 5F and 5G show another way of increasing the angular range of the illumination light without reducing its brightness. In order to achieve this effect, at least one positive lens 516 is inserted between the light source and the slide. It is easy to see that the higher the refractive index of the lens, the higher the ray angle range. The lens does not need to be of a high precision because quite a large amount of aberration is tolerable. Therefore, the lens is usually less expensive than the tapered light-pipe. However, packaging the illumination system is usually more difficult with lenses.

FIG. 5H shows another way of increasing the angular range of the illumination light. It uses both a tapered light-pipe 515 and a positive lens 516. This method is expected to avoid a long light-pipe and to make the mechanical packaging manageable for some applications.

In the examples shown, the illumination light filled the available optical solid-angle space completely or substantially. However, the illumination can also be made to fill only a small portion of the available optical solid-angle space.

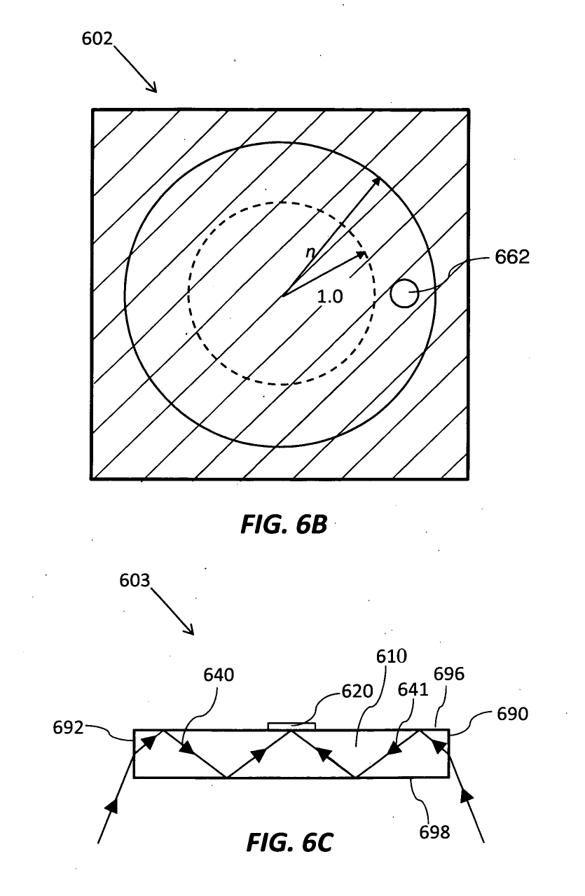

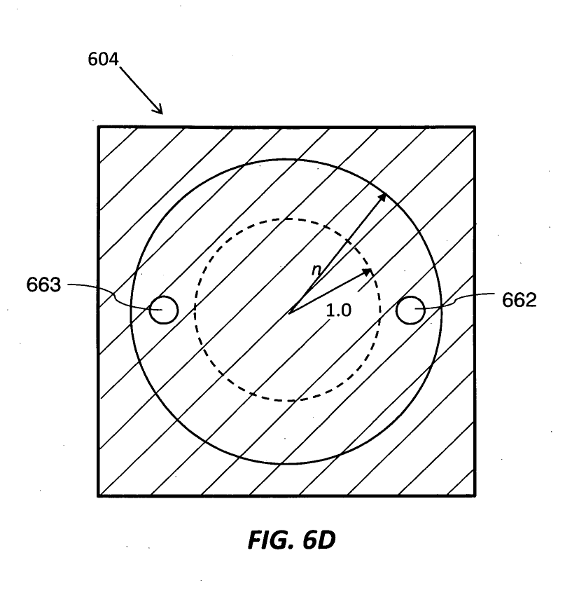

FIG. 6A shows such an example. In the example, a well-directed bundle of illumination rays 640 is introduced through one of the side surfaces 692 of the sample slide 610 to illuminate the sample 620. In this case, the illumination ray bundle occupies a small area 662 in the optical solid-angle space as shown in FIG. 6B.

FIG. 6C shows another example. In the example, two illumination ray bundles 640 and 641 are introduced through two opposite side surfaces 692 and 690 of the sample slide 610 to illuminate the sample 620. In this case, the two illumination ray bundles occupy two small areas 662 and 663 in the optical solid-angle space as shown in FIG. 6D.

So far, several methods for incrementing the angular range of the illumination light have been discussed. However, note that the same methods can also be used to reduce the angular range of the illumination light. If the taper direction is reversed or a negative lens is used, the angular range of the illumination light will be reduced rather than increased.

Note that none of the glass interfaces in the new illumination system need to be filled with an index-matching liquid. This makes the handling and retrofitting of the illuminator to existing imaging systems easy.

In an example, top and bottom of the microscope slide or coplanar pieces of glass may be used to constrain the illumination in the plane normal to the microscope axis.

### APPLICATIONS

There are various applications of the illumination systems and methods disclosed herein. The following is a partial list of possible applications:

1. High intensity dark-field illumination: Most dark-field imaging applications are light-starved because they collect scattered light only. This is especially true when the sample scatters light weakly. An example is a dark-field observation of biological cells or tissues. Most biological samples scatter light very weakly. Conventional dark-field illumination techniques cannot provide an intense illumination due to their limited optical solid-angle space. Therefore, it is hard to observe biological samples in the dark-field mode using a conventional illumination technique. The new illumination technique disclosed herein can increase the illumination intensity multiple times. Therefore, many applications where dark-field imaging is not practical due to the weak illumination intensity of the conventional dark-field illumination techniques will be able to use dark-field imaging techniques with the new illumination systems and methods disclosed herein.

2. Fluorescence microscopy: Most fluorescence microscopy requires an intense illumination of the sample because most materials fluoresce very weakly. This is especially true for time-resolved fluorescence microscopy because it requires an illumination burst of short duration. The intensity of fluorescence is proportional to the intensity of the sample illumination. Therefore, the new illumination systems and methods disclosed herein can increase the intensity of fluorescence by multiple folds. Most florescence microscopy systems prefer dark-field illumination because it makes the filtering of illumination wavelengths much easier. The illumination systems and methods disclosed herein are well-suited for the dark-field fluorescence microscopy because they can generate very intense illumination levels in a dark-field mode of operation.

3. Raman spectroscopy: Most Raman spectroscopy requires extremely high illumination intensity in a narrow bandwidth. Also, Raman spectroscopy is not very sensitive to the choice of illumination wavelength. Therefore, lasers are naturally the most popular choice as a light source for Raman spectroscopy. However, some applications, such as a combined spectroscopy of Raman and fluorescence, are sensitive to the choice of illumination wavelength. In this case, a laser is hard to use as the light source because of the limited wavelength choice. A broadband light source such as an arc lamp is preferred because of the easiness of the wavelength choice. However, broadband light sources cannot usually provide an intense enough illumination level on the sample using conventional illumination techniques. The systems and methods disclosed herein can potentially solve this low illumination level intensity problem. The configurations using dual slides shown in FIGS. 3A, 3B and 4B may be able to provide enough illumination intensity for Raman spectroscopy.

The illumination systems and methods disclosed herein can be applied to other applications than microscopy. For example, it can be applied to the imaging with a pinhole camera where an intense sample illumination is needed or very desirable. It may also be applied to display systems that require intense illumination of the samples. The applications mentioned herein should be interpreted as a partial list rather than a complete one.

What is claimed is:

1. A method of illuminating a sample, comprising:
supporting the sample on a transparent slide, transparent slide having a refractive index n, opposing top and bottom substantially planar surfaces, and at least one side, the transparent slide defining an optical solid-angle space, with the sample being operably supported on the upper planar surface; and
introducing light into the transparent slide through the at least one side of the transparent slide to illuminate a portion of the optical solid-angle space between 1 and n, with the illuminated portion extending out to n, wherein the light in the illuminated portion illuminates the sample through the substantially planar upper surface

2. The method of claim 1, wherein the illuminated portion extends from 1 to n.

3. The method of claim 1, wherein the illuminated portion fills the entire available optical solid-angle space between 1 and n.

4. The method of claim 1, wherein the transparent slide is substantially rectangular and has four sides, and further comprising introducing the light into the transparent slide from at least one of the four sides.

5. The method of claim 4, including providing a reflective surface on at least one of the four sides.

6. The method of claim 1, further comprising introducing the light by sending the light from a light source through at least one optical fiber bundle optically coupled at a proximal end to the light source and optically coupled at a distal end to the at least one side.

7. The method of claim 6, further comprising sending the light through at least one tapered light pipe operably arranged between the optical fiber bundle distal end and the at least one side of the transparent slide.

8. The method of claim 1, further comprising introducing the light by sending the light from a light source through at least one lens that is operably arranged relative to a light source and to the at least one side.

9. The method of claim 1, further sending light through the bottom surface of the transparent slide to illuminate at least a portion of the optical solid-angle space between 0 and 1.

10. The method of claim 1, wherein the light undergoes at least one internal reflection within the transparent slide prior to being incident upon the sample.

11. A method of illuminating a sample, comprising:
providing first and second transparent slides having respective first and second refractive indices n₁ and n₂ and first and second optical solid-angle spaces, with each of the first and second transparent slides having opposing substantially planar surfaces and at least one side;
sandwiching the sample between the planar surfaces of the first and second transparent slides; and
introducing light into the first and second transparent slides through each of the at least one sides to fill respective first and second portions of the first and second optical solid-angle spaces, with the first filled portion being between 1 and n₁ and extending out to n₁, and the second filled portion being between 1 and n₂ and extending out to n₂, wherein the light in the filled first and second portions illuminates the sample.

12. The method of claim 11, further comprising sending light through the respective planar surfaces of the first and second transparent slides to fill the first optical solid angle space in a region between 0 and 1 and to fill the second optical solid-angle space in a second region between 0 and 1.

13. The method of claim 11, further comprising providing first and second reflecting coatings on respective at least one sides of the first and second transparent slides.

14. The method of claim 11, wherein the planar surfaces of the first and second transparent slides define a gap within which the sample resides, and further comprising introducing an index-matching liquid into the gap.

15. The method of claim 11, further comprising each of the first and second transparent slides being rectangular and including four sides.

16. An illumination system for illuminating a sample at a high optical solid angle, the sample having top and bottom surfaces, comprising:
a transparent slide having top and bottom substantially planar surfaces and at least one side, with the sample operably supported with its bottom surface in optical contact with the top substantially planar surface of the transparent slide, the transparent slide having a refractive index n and defining an optical solid-angle space; and
a light source optically coupled to the at least one side of the transparent slide such that light from the light source enters the at least one side and fills a portion of the optical solid-angle space between 1 and n, wherein the filled portion extends out to n, with light from the filled portion illuminating the sample through the top substantially planar surface of the transparent slide.

17. The illumination system of claim 16, wherein the light source is optically coupled to the at least one side such that the light from the light source fills the entire optical solid angle space between 1 and n.

18. The illumination system of claim 16, further comprising:
another transparent slide having top and bottom substantially planar surfaces and at least one side, the another transparent slide having a refractive index n′ and defining another optical solid-angle space, with the another transparent slide arranged with its bottom planar surface optically contacting the top surface of the sample; and
the light source optically coupled to the another transparent slide at its at least one side to fill a portion of the another optical solid-angle space between 1 and n′, wherein the illuminated portion extends out to n′, with light from the filled portion of the another optical solid-angle space illuminating the sample through the bottom substantially planar surface of the another transparent slide.

19. The illumination system of claim 18, wherein the sandwiched transparent slides define a gap within which the sample resides, and further comprising an index-matching fluid in the gap.

20. The illumination system of claim 16, further comprising an imaging system operably arranged relative to the sample and configured to form an image of the illuminated sample.
